(19) United States
(12) Patent Application Publication
(10) Pub. No.: US 2016/0001870 A1
(43) Pub. Date: Jan. 7, 2016

(54) METHOD FOR LOADING CARGO INTO AN AIRCRAFT

(71) Applicant: Ancra International LLC, Azusa, CA (US)

(72) Inventors: EDWARD MORADIANS, Woodland Hills, CA (US); John F. Rowles, Fullerton, CA (US)

(73) Assignee: Ancra International LLC, Azusa, CA (US)

(21) Appl. No.: 14/750,571

(22) Filed: Jun. 25, 2015

Related U.S. Application Data
(60) Provisional application No. 62/021,536, filed on Jul. 7, 2014.

(51) Int. Cl. B64C 1/22

(52) U.S. Cl. CPC B64C 1/22

(57) ABSTRACT

A method of loading cargo into an aircraft is provided. The method includes the steps of sliding a cargo unit through a cargo door opening of an aircraft and into a cargo compartment of the aircraft perpendicular to a longitudinal axis of the aircraft. The cargo is slid past and in contact with a first restraint, wherein the first restraint is fixed to a seat track disposed proximate to the cargo door opening, such that a side surface of the cargo unit contacts a portion of the first restraint. The cargo continues to slide into the cargo compartment, and does not contact a side surface of a second restraint that is fixed inboard of the first seat track, wherein a forward facing surface of each of the first and second restraints are disposed along a plane substantially perpendicular to the longitudinal axis.

### CROSS-REFERENCE TO RELATED APPLICATIONS

This application claims priority from U.S. Provisional Application No. 62/021,536, filed on Jul. 7, 2014, the entirety of which is hereby fully incorporated by reference herein.

### TECHNICAL FIELD

This disclosure relates to structures to assist with loading cargo containers (such as unit load devices) into a commercial aircraft, and specifically to structures and methods to facilitate the efficient loading of cargo while minimizing damage to the aircraft and the loading equipment.

### BRIEF SUMMARY

A first representative embodiment of the disclosure is provided. The embodiment includes a method of loading cargo into an aircraft. The method includes the steps of sliding a cargo unit through a cargo door opening of an aircraft and into a cargo compartment of the aircraft along a direction perpendicular to a longitudinal axis of the aircraft that extends in a fore and an aft direction. The method further includes the step of sliding the cargo unit past and in contact with a first restraint, wherein the first restraint is fixed to a seat track disposed proximate to the cargo door opening, wherein the first restraint is aligned such that a side surface of the cargo unit contacts a portion of the first restraint. The method further includes continuing to slide the cargo unit into the cargo compartment, wherein the cargo unit does not contact a side surface of a second restraint that is fixed to a second seat track that is adjacent to the first seat track and disposed inboard of the first seat track, wherein a forward facing surface of each of the first and second restraints are disposed along a plane substantially perpendicular to the longitudinal axis.

Another representative embodiment is provided. The embodiment includes a method of equipping an aircraft for loading cargo. The method includes the step of providing a second cargo restraint within a cargo compartment in an aircraft at a first position upon a roll plane within the cargo compartment, the second cargo restraint configured to restrain cargo based upon expected forces in a fore direction and/or an aft direction within the cargo compartment of the aircraft. The method further includes the step of providing a first restraint between a cargo door opening of the aircraft and the first cargo restraint, the second restraint is positioned such that cargo that enters the cargo compartment through the cargo door opening in a direction perpendicular to a longitudinal axis of the aircraft in the fore and aft direction is prevented from contact with a side surface of the second restraint as the cargo slides past the first restraint in the perpendicular direction.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a sub assembly that spacingly retains first and second retainers for use within a cargo handling system within a cargo compartment of an aircraft.

FIG. 1a is the view of FIG. 1 with the first restraint disposed forward of the second restraint, in an alternate embodiment.

FIG. 2 is the view of FIG. 1 with a pawl of the first restraint disposed in a second lowered position.

FIG. 3 is a top view of the sub assembly of FIG. 1 disposed within a cargo compartment of an aircraft.

FIG. 4 is the view of FIG. 3 with a cargo unit contacting the first restraint.

FIG. 5 is the view of FIG. 4 with the cargo unit slid further to contact the second restraint.

FIG. 6 is an exemplary top view of a second restraint usable with the sub assembly of FIG. 1.

FIG. 7 is a side view of the exemplary second restraint of FIG. 6.

### DETAILED DESCRIPTION OF THE DRAWINGS AND THE PRESENTLY PREFERRED EMBODIMENTS

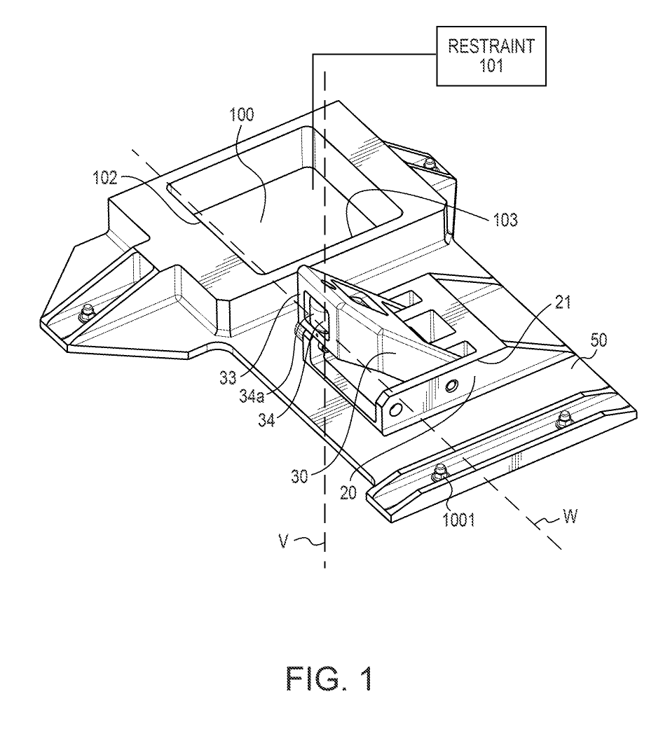

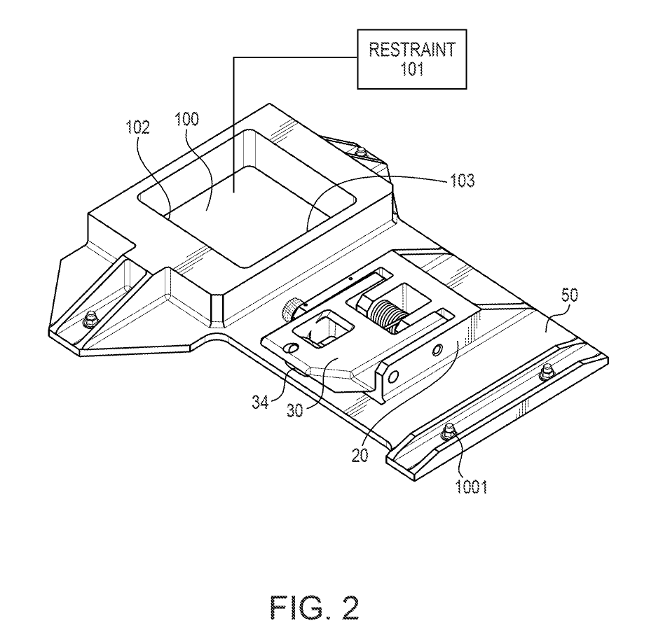

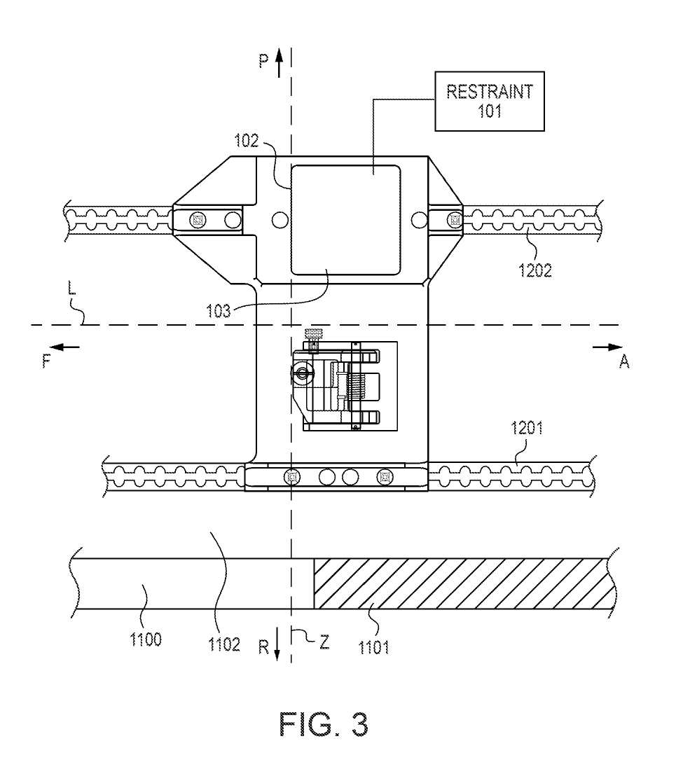

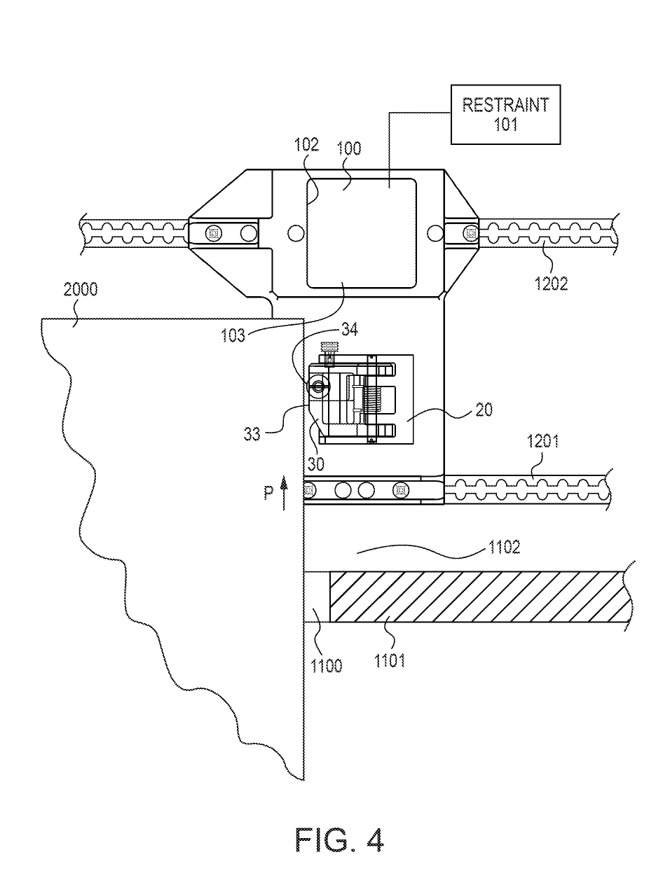

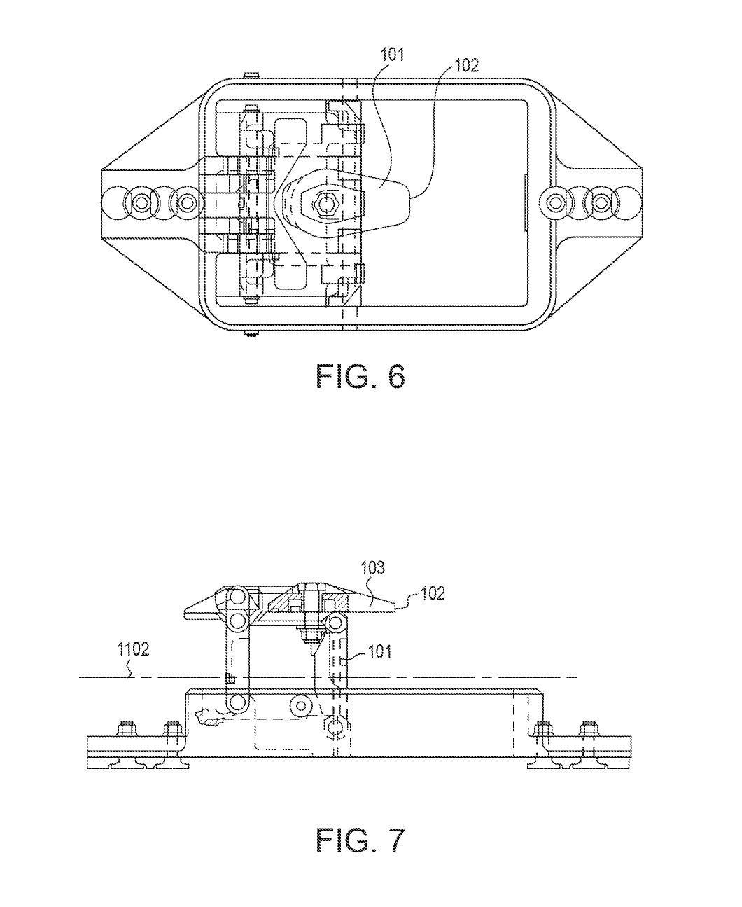

Turning now to FIGS. 1-7, a method for loading cargo onto an aircraft is provided, and a method of equipping an aircraft for loading cargo 2000 is also provided. The method is intended for use in a commercial aircraft 1101, and specifically configured for use with a commercial aircraft that includes one or more side doors 1100 that can receive cargo units (ULD) 2000 therethrough, which are positioned within the cargo compartment in a manner to maximize the amount of cargo 2000 that can be positioned within the cargo compartment. In some embodiments, the cargo units 2000 may be slid about a roll plane 1102 (shown schematically in FIG. 7, which may be above the surfaces of the first and second restraints 20, 101, discussed below, or formed by portions of the restraints) with a plurality of conventional structures that are configured to allow cargo units to be moved either in a fore/aft direction (F, A, FIG. 3, i.e. along or parallel to a longitudinal axis L) and/or in a perpendicular direction (P, R, FIG. 3, i.e. along or parallel to an axis Z that is perpendicular to the longitudinal axis L). The roll plane may include the combined portions of rollers, ball and socket rollers, power drive units, or other structures that are configured to allow or assist cargo units being translated within a cargo compartment.

As best shown in FIGS. 1-5, a first restraint 20 is fixedly mounted upon the deck of the aircraft 1101 within the cargo compartment, such as directly mounted to a seat track 1201, or in other embodiments, the first restraint 20 may be fixedly mounted to a sub assembly 50, which is fixedly mounted to one or more seat tracks 1201, 1202. The first restraint 20 (or sub assembly 50, when provided) may be removably fixed to the seat track(s) 1201, 1202 with one or both of shear studs (not shown, but conventional) and tension studs 1001, as are known in the art. In some embodiments, the first restraint 20 may be mounted to a first seat track inboard from the cargo door opening 1100. In embodiments, where the first restraint 20 is not directly fixed to a seat track, the first restraint 20 may be disposed directly above, or in other embodiments, proximate to, the first seat track inboard of the cargo door opening 1100. In other embodiments, the first restraint 20 may be fixed in other positions within the cargo compartment, such as proximate to a second inboard seat track, or in still other positions where the position of the first restraint 20 guides cargo that enters into the cargo compartment (or moves within the cargo compartment) such that the cargo 2000 is specifically directed or aligned with respect to other restraints, or structures, within the cargo compartment.

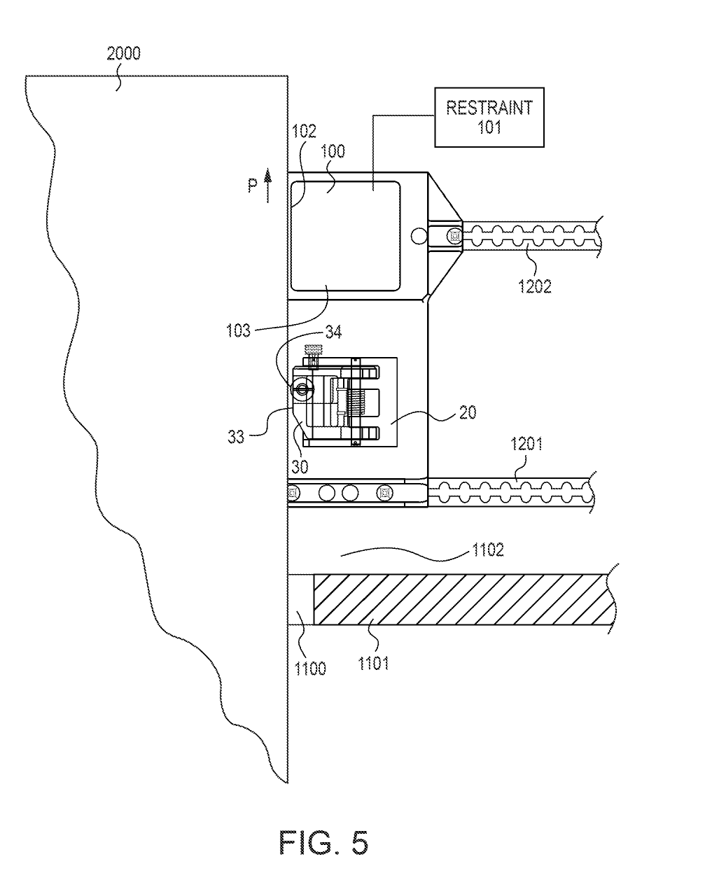

The first restraint 20, in some embodiments, may include a pawl (or an arm, or another similar structure) 30 that is pivotably mounted upon a base 21. The pawl 30 may be fixed in a first position (FIG. 1) where the pawl 30, and specifically a forward face 33 of the pawl 30, is configured to interact with cargo units 2000 that are slid through cargo opening 1100 (associated with the side door (not shown) formed by a side wall 1101 of the aircraft) in a direction perpendicular to the longitudinal axis L of the aircraft, as discussed below. The forward face 33 may be a planar surface that faces in the fore direction within the aircraft. In some embodiments, the pawl 30 may rotatably support a roller 34, which rotates about a vertical axis V when the pawl 30 is in the first position. In some embodiments, the roller 34 is positioned such that a side surface of the roller 34 extends just slightly forward of the forward face 33, such as 0.1 inches, or even smaller distances. In some embodiments, the roller 34 is positioned such that the side surface of the roller 34 (which extends in the fore direction, based upon the rotational position of the roller 34) is disposed in-line with a forward surface 102 of a second restraint 101, as shown schematically in FIG. 1 with the line W (and an exemplary forward surface 102 shown in FIGS. 6 and 7). The second restraint 101 is discussed below, and may be disposed inboard of the first restraint 20, such as on a seat track 1202 that is adjacent to and inboard of the first seat track 1201 that receives the first restraint 20. When provided, the assembly 50 may support both the first and second restraints 20, 101.

In other embodiments depicted in FIG. 1a, the side surface 34a of the roller 34 (and other portions of the pawl 30) may be disposed forward of the second restraint 101, but a distance A, as schematically depicted in FIG. 1a. In these embodiments, the first restraint 20 may be useful at preventing contact between the cargo 2000 and the second restraint after the cargo 2000 slides past the first restraint 20 in the direction P perpendicular to the longitudinal axis L of the aircraft.

The pawl 30 may be fixed in the first position in order to contact a cargo unit 2000 (and multiple cargo units 2000, sequentially) that enters the cargo compartment from the aircraft's side door 1100 and guide the cargo 2000 to continue within the cargo compartment in the perpendicular direction P to the longitudinal axis L of the aircraft. The pawl 30 may be formed to have a sufficient strength to withstand loads from cargo units 2000 that approach and contact a side surface 32 of the pawl 30, such as cargo units 2000 that enter through the cargo door opening 1100 somewhat aft of the forward surface 30, and/or cargo units 2000 that reach the pawl 30 at an angle of attack that is at an acute angle to the longitudinal axis L.

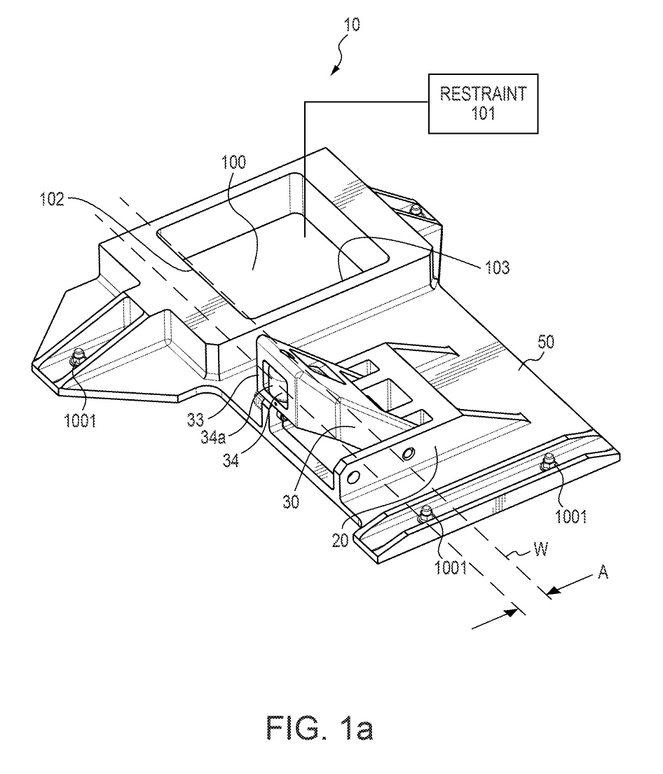

The pawl 30 may be pivotable to, and be fixed in, a second position (FIG. 2) where the pawl 30 extends below the roll plane (or in some embodiments forms a portion of the roll plane). The pawl 30 may be fixed in the second position, and may be pivoted between, and fixed in each of first and second positions with conventional structures and mechanisms that are known in the art of cargo loading devices for aircraft. One of ordinary skill in the art will understand, with a thorough review of this disclosure, the types of pawls (or other types of arms or similar structures) 30, and the types of locking and rotating mechanisms for the pawl 30 that are suitable for the pawl 30. When the pawl 30 is in the second position, the pawl 30 (and the remainder of the first restraint 20) does not interact with cargo 2000 as it enters into and moves within the cargo compartment of the aircraft.

The second restraint 101 is shown schematically in FIGS. 1-5. The second restraint 101 may be any type of restraint that is configured to direct moving cargo 2000 within a cargo compartment of an aircraft and/or the second restraint 101 may be any type of restraint that is configured to restrain cargo 2000, and specifically restrain cargo in expected or potential forces in fore and/or aft direction, within a cargo compartment during flight. In some embodiments, the second restraint 101 may be a pallet lock, an end lock, a lock, or an XY lock, as are each known in the art and as disclosed in commonly assigned U.S. Pat. No. 5,573,359 to Moradians, the entirety of which is hereby incorporated by reference herein. In embodiments where the second restraint 101 is disposed in a BOEING® 767 aircraft, the second restraint 101 may be a P3 Lock. In some embodiments, the second restraint 101 may be a restraint (or a guide for moving cargo) that is not configured to accept side loads (or to tolerate impacts upon a side (inboard or outboard) surface of the restraint). In some embodiments, the second restraint 101 may be configured to be disposed in an extended position where at least a portion of the second restraint 101 extends above the roll plane, and a second position where the second restraint 101 is disposed below the roll plane.

FIGS. 1-5, which schematically depict the second restraint 101, depict a space 100 where the second restraint 101 may be positioned, with respect to the first restraint 20. The figures additionally depict a forward surface 102 of the space 100, and a plane that extends parallel through the forward surface 102 is also the plane where a forward face (or portion, in some embodiments) of the second restraint 101 is located. As shown in FIG. 1, line W extends in parallel with a plane that extends through the forward surface 102.

In some embodiments, the second restraint 101 may be fixedly mounted to the aircraft, such as directly mounted to a seat track 1202 within an aircraft, or, as discussed below, fixed to a sub assembly 50, which is fixed to a seat track. In some embodiments, the second restraint 101 may be ultimately fixed to a seat track 1202 that is adjacent to and inboard of the seat track 1201 that receives the first restraint 20. In other embodiments, the second restraint 101 may be fixed to a seat track that is spaced from the seat track 1201, with intervening seat tracks disposed therebetween. In some embodiments, the first restraint 20 may be disposed between the cargo door opening 1100 and the second restraint 101.

As discussed above, in some embodiments, the second restraint 101 may be fixed to a sub assembly 50, which itself is fixed to one or more seat tracks (such as 1201, 1202). As discussed above, the sub assembly 50 may include tension studs (e.g. 1001) and shear studs to fix to a seat track as conventional. The sub assembly 50 may also support the first restraint 20, or the sub assembly 50 that supports the second restraint 101 may support only the second restraint 101, or may support a combination of the second restraint 101 and other structures within the cargo compartment. The second restraint 101 and/or the sub assembly 50 that supports the second restraint 101 may be movable to a retracted position where the second restraint 101 is below (or forms a portion of) the roll plane when not in use.

In some embodiments, the first restraint 20 is fixed within a cargo compartment of a BOEING® 767 aircraft, and more specifically proximate to a cargo door opening 1100 of a BOEING® 767 aircraft. One of ordinary skill in the art will be familiar with the general design of the cargo compartment and the doors (openings and the doors themselves) of this aircraft. Specifically, one of ordinary skill in the art will appreciate that the BOEING® 767 aircraft is designed without a foldable or removable door sill protector that, other aircraft models is aligned with an aircraft cargo door opening, which is found on other types of aircraft that is suited for carrying cargo within the cargo compartment.

In some embodiments, a method of equipping an aircraft for loading cargo is provided. The method includes the step of providing a second cargo restraint 101 within a cargo compartment in an aircraft at a first position upon a roll plane within the cargo compartment, the second cargo restraint 101 configured to restrain cargo based upon expected forces in a fore direction and/or an aft direction within the cargo compartment of the aircraft. The method further includes the step of providing a first restraint 20 between a cargo door opening 1100 of the aircraft and the first cargo restraint, the second restraint is positioned such that cargo that enters the cargo compartment through the cargo door opening 1100 in a direction perpendicular to a longitudinal axis L of the aircraft in the fore and aft direction is prevented from contact with a side surface 103 (shown schematically in FIG. 1, and an exemplary side surface 103 in FIG. 7) of the second restraint 101 as the cargo slides past the first restraint 20 in the perpendicular direction P.

The method may further include the first restraint 20 including a rotatable pawl 30 that can be locked in a first position disposed to engage the cargo that enters the aircraft though the cargo door opening, and can be locked in a second position wherein the pawl 30 is disposed below a roll plane within the cargo compartment.

The method may further include a rotatable pawl 30 in the first restraint that includes a roller 34 that rotates about a vertical axis V when the rotatable pawl is disposed in the first position.

The method may further include the first restraint 20 fixedly mounted upon a first seat track 1201 within the cargo compartment closest to the cargo door opening 1100, and the second restraint 101 that is fixedly mounted upon a second seat track 1202 disposed adjacent to the first seat track 1201.

The method may further include equipping a BOEING® 767 aircraft as discussed above.

The method may further include equipping an aircraft that is configured without a door sill protector aligned with the aircraft cargo door opening 1100 as discussed above.

The method may further include the first and second restraints arranged such that cargo slides past and contacts a forward facing surface 102 of the second restraint 101 after sliding past the first restraint 20.

A method of loading cargo into an aircraft is provided. The method includes the steps of sliding a cargo unit 2000 through a cargo door opening 1100 of an aircraft and into a cargo compartment of the aircraft along a direction P perpendicular to a longitudinal axis L of the aircraft that extends in a fore and an aft direction. The method further includes the step of sliding the cargo unit 2000 past and in contact with a first restraint 20, wherein the first restraint 20 is fixed to a seat track 1201 disposed proximate to the cargo door opening 1100, wherein the first restraint 20 is aligned such that a side surface of the cargo unit 2000 contacts a portion of the first restraint 20. The method further includes continuing to slide the cargo unit 2000 into the cargo compartment, wherein the cargo unit 2000 does not contact a side surface 103 of a second restraint 101 that is fixed to a second seat track 1202 that is adjacent to the first seat track 1201 and disposed inboard of the first seat track 1201, wherein a forward facing surface 33, 102 of each of the first and second restraints are disposed along a plane substantially perpendicular to the longitudinal axis L.

The first restraint 20 of the above method may include a rotatable pawl 30 that can be locked in a first position disposed to engage cargo 2000 that slides therepast, and can be selectively locked in a second position wherein the pawl 30 is disposed below a roll plane RP within the cargo compartment, the method further comprising the step of positioning the pawl 30 in the first position prior to sliding the cargo unit through the cargo door opening 1100 of the aircraft.

The above method may include a pawl 30 with a roller 34 that rotates about a vertical axis V when the pawl is disposed in the first position, wherein the roller 34 is configured to contact cargo that slides therepast in the perpendicular direction P.

The above method, wherein the second restraint 101 includes a side surface 103 that faces perpendicularly to the longitudinal axis of the aircraft.

The method may further include equipping a BOEING® 767 aircraft as discussed above.

The method may further include equipping an aircraft is configured without a door sill protector aligned with the aircraft cargo door opening 1100 as discussed above.

The above method, wherein the first restraint is fixed to a first seat track adjacent to the cargo door opening, and the second restraint is fixed to a second seat track adjacent to and inboard of the first seat track.

The above method, wherein the first seat track is directly next to the cargo door opening with no seat tracks disposed therebetween.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

1. A method of equipping an aircraft for loading cargo, comprising:
providing a first cargo restraint within a cargo compartment in an aircraft at a first position within the cargo compartment, the first cargo restraint configured to restrain cargo based upon expected forces in a fore direction and/or an aft direction within the cargo compartment of the aircraft; and
providing a second restraint between a cargo door opening of the aircraft and the first cargo restraint, the second restraint is positioned such that cargo that enters the cargo compartment through the cargo door opening in a direction perpendicular to a longitudinal axis of the aircraft in the fore and aft direction is prevented from contact with a side surface of the first restraint as the cargo slides past the second restraint in the perpendicular direction.

2. The method of claim 1, wherein the second restraint includes a rotatable pawl that can be locked in a first position disposed to engage the cargo that enters the aircraft though the cargo door opening, and can be locked in a second position wherein the pawl is disposed below a roll plane within the cargo compartment.

3. The method of claim 1, wherein the rotatable pawl comprises a roller that rotates about a vertical axis when the rotatable pawl is disposed in the first position.

4. The method of claim 1, wherein the second restraint is fixedly mounted upon a first seat track within the cargo compartment closest to the cargo door opening, and the first restraint is fixedly mounted upon a second seat track disposed adjacent to the first seat track.

5. The method of claim 1, wherein the aircraft is a BOEING® 767 aircraft.

6. The method of claim 1, wherein the aircraft is configured without a door sill protector aligned with the cargo door opening.

7. The method of claim 1, wherein the cargo slides past and contacts a forward facing surface of the first restraint after sliding past the second restraint.

8. A method of loading cargo into an aircraft, comprising:
sliding a cargo unit through a cargo door opening of an aircraft and into a cargo compartment of the aircraft along a direction perpendicular to a longitudinal axis of the aircraft that extends in a fore and an aft direction,
sliding the cargo unit past and in contact with a first restraint, wherein the first restraint is fixed to proximate to the cargo door opening, wherein the first restraint is aligned such that a side surface of the cargo unit contacts a portion of the first restraint; and
continuing to slide the cargo unit into the cargo compartment, wherein the cargo unit does not contact a side surface of a second restraint that is fixed inboard of the first seat track, wherein a forward facing surface of each of the first and second restraints are disposed along a plane substantially perpendicular to the longitudinal axis.

9. The method of loading cargo of claim 8, wherein the first restraint includes a rotatable pawl that can be locked in a first position disposed to engage cargo that slides therepast, and can be selectively locked in a second position wherein the pawl is disposed below a roll plane within the cargo compartment, further comprising the step of positioning the pawl in the first position prior to sliding the cargo unit through the cargo door opening of the aircraft.

10. The method of loading cargo of claim 9, wherein the pawl includes a roller that rotates about a vertical axis when the pawl is disposed in the first position, wherein the roller is configured to contact cargo that slides therepast in the perpendicular direction.

11. The method of claim 8, wherein the side surface of the second restraint is a surface that faces perpendicularly to the longitudinal axis of the aircraft.

12. The method of claim 8, wherein the first restraint is fixed to a seat track that is closest to the cargo door opening within the cargo compartment of the aircraft.

13. The method of claim 8, wherein the aircraft is a BOEING® 767 aircraft.

14. The method of claim 8, wherein the aircraft is configured without a door sill protector aligned with the cargo door opening.

15. The method of claim 8, wherein the first restraint is fixed to a first seat track adjacent to the cargo door opening, and the second restraint is fixed to a second seat track adjacent to and inboard of the first seat track.

16. The method of claim 15, wherein the first seat track is directly next to the cargo door opening with no seat tracks disposed therebetween.
